(19) United States
(12) Patent Application Publication
(10) Pub. No.: US 2015/0279098 A1
(43) Pub. Date: Oct. 1, 2015

(54) SMART DEVICE AND VIRTUAL EXPERIENCE PROVIDING SERVER PROVIDING VIRTUAL EXPERIENCE SERVICE METHOD USING DIGITALEXPERIENCE SERVICE METHOD USING DIGITAL CLOTHES

(71) Applicant: Electronics and Telecommunications Research Institute, Daejeon (KR)

(72) Inventors: Ho Won KIM, Seoul (KR); Kyu Sung CHO, Suwon-si Gyeonggi-do (KR); Tae Joon KIM, Daejeon (KR); Sung Ryull SOHN, Daejeon (KR); Jin Sung CHOI, Daejeon (KR); Bon Ki KOO, Daejeon (KR); Ki Nam KIM, Seoul (KR)

(21) Appl. No.: 14/668,658

(22) Filed: Mar. 25, 2015

(30) Foreign Application Priority Data
Mar. 27, 2014 (KR) 10-2014-0036226

(51) Int. Cl. G06T 17/20

(52) U.S. Cl. CPC G06T 17/20; G06T 2200/04; G06T 2207/10004; G06T 2207/10028; G06T 2207/30196; G06T 2210/16; G06T 2215/16; G06T 2219/2004

(57) ABSTRACT

A smart terminal, a virtual experience providing server and methods of the same are disclosed. The smart terminal determines avatar identification information to identify a user avatar and clothing identification information to identify digital clothing and displays a virtual experience image overlaid with the digital clothing simulated on the user avatar, provided from the virtual experience providing server.

### CROSS-REFERENCE TO RELATED APPLICATION

This application claims the priority benefit of Korean Patent Application No. 10-2014-0036226, filed on Mar. 27, 2014, in the Korean Intellectual Property Office, the disclosure of which is incorporated herein by reference.

### BACKGROUND

1. Field of the Invention

The following description of embodiments relates to a smart device and virtual experience providing server which provide a virtual experience service method using digital clothes, and more particularly, to a virtual clothing experience service capable of virtually simulating digital clothing provided from a store, the Internet or a home shopping on a life-size three-dimensional (3D) avatar of a user and of verifying a simulation result.

2. Description of the Related Art

With the recent introduction of a depth sensor, for example, Kinect, shape information relating to an appearance of a user and motion information on joints included in the shape information are easily and conveniently obtainable with low costs. Accordingly, various changes are caused to games or existing user interfaces, and diverse user participating services are emerging. Representative services include a virtual clothing experience service of receiving an input of a user motion in real time, wearing clothes, and striking a pose.

The virtual clothing experience service is provided to a user through a specific terminal, for example, a kiosk system of an offline store or a TV plus PC environment. However, the virtual clothing experience service is provided to a user as an event just for fun but does not result in a purchase. That is, the virtual clothing experience service is merely a one-time experience service provided to a user, involving restrictions in utilization for actually measured size information on the user or fitting clothes corresponding to the experience service.

That is, as the virtual clothing experience service is provided as a one-time experience service, the size information on the user may not be accurately measured and appearance data based on the size information may be absent. Moreover, the virtual clothing experience service may simulate limited types of clothes as clothes simulated on the appearance data are different from clothes on sale.

To solve such problems, a virtual clothing experience terminal and solution are used in recent years. The virtual clothing experience terminal is a terminal in a kiosk type for experience, for example, a 3D full body scanner, which is capable of obtaining actual measurements of a human body or appearance data. The solution is used to make digital clothing through draping and simulation using a real clothing pattern, such as CLO3D, for creating digital clothing contents of real clothing currently on sale.

However, the virtual clothing experience terminal and solution merely provide a fitting service of trying on clothing stored in a server using avatar information provided by a client based on a server-client structure but does not provide a real-time fitting service of trying on clothing corresponding to environments of real life.

Thus, methods of checking a look, a feel and size information on clothing to purchase through various advance experiences on the clothing before purchase irrespective of places and circumstances, such as home, stores and mobile, are suggested to solve unsatisfactory purchases or returns caused by non-experience purchases.

### SUMMARY

An aspect of the present invention provides a smart terminal and a virtual experience providing server which provide a virtual experience service of trying on clothing provided from a store, the Internet or a home shopping, irrespective of time and place, using a life-size three-dimensional (3D) avatar of a user and link to a service enabling directly purchase of the clothing after virtual experience, thereby enabling virtual experience of matching information on the user with the clothing or size information on the clothing before purchasing the clothing.

According to an aspect of the present invention, there is provided a virtual experience service method performed by a smart terminal, the method including: determining avatar identification information to identify a user avatar created from an avatar creation terminal; determining clothing identification information to identify digital clothing; and displaying a virtual experience image overlaid with the digital clothing simulated on the user avatar, wherein the displaying is provided with and displays the virtual experience image from a virtual experience providing server overlaying the digital clothing simulated on the user avatar on user pose information based on the avatar identification information and the clothing identification information.

According to another aspect of the present invention, there is provided a virtual experience service method performed by a smart terminal, the method including: determining avatar identification information to identify a user avatar created from an avatar creation terminal; determining clothing identification information to identify digital clothing; simulating the digital clothing on the user avatar based on the avatar identification information and the clothing identification information; generating a virtual experience image by overlaying the simulated digital clothing on a color image of user pose information; and displaying the generated virtual experience image.

According to an aspect of the present invention, there is provided a virtual experience service method performed by a virtual experience providing server, the method including: extracting a user avatar corresponding to avatar identification information received from a smart terminal; extracting digital clothing corresponding to clothing identification information received from the smart terminal; generating a virtual experience image overlaid with the digital clothing simulated on the user avatar based on the user avatar and the digital clothing; and providing the generated virtual experience image to the smart terminal, wherein the providing provides the generated virtual experience image to the smart terminal which transmits the avatar identification information and the clothing identification information to the virtual experience providing server and is provided with and displays the virtual experience image generated by the virtual experience providing server.

According to an aspect of the present invention, there is provided a smart terminal including: an avatar identification information determination unit to determine avatar identification information to identify a user avatar created from an avatar creation terminal; a clothing identification information determination unit to determine clothing identification information to identify digital clothing; and a display unit to display a virtual experience image overlaid with the digital clothing simulated on the user avatar, wherein the display unit is provided with and displays the virtual experience image from a virtual experience providing server overlaying the digital clothing simulated on the user avatar on user pose information based on the avatar identification information and the clothing identification information.

According to another aspect of the present invention, there is provided a smart terminal including: an avatar identification information determination unit to determine avatar identification information to identify a user avatar created from an avatar creation terminal; a clothing identification information determination unit to determine clothing identification information to identify digital clothing; a simulation unit to simulate the digital clothing on the user avatar based on the avatar identification information and the clothing identification information; a virtual experience image generation unit to generate a virtual experience image by overlaying the simulated digital clothing on a color image of user pose information; and a display unit to display the generated virtual experience image.

According to an aspect of the present invention, there is provided a virtual experience providing server including: a user avatar extraction unit to extract a user avatar corresponding to avatar identification information received from a smart terminal; a digital clothing extraction unit to extract digital clothing corresponding to clothing identification information received from the smart terminal; a virtual experience image generation unit to generate a virtual experience image overlaid with the digital clothing simulated on the user avatar based on the user avatar and the digital clothing; and a virtual experience image providing unit to provide the generated virtual experience image to the smart terminal, wherein the virtual experience image providing unit the generated virtual experience image to the smart terminal which transmits the avatar identification information and the clothing identification information to the virtual experience providing server and is provided with and displays the virtual experience image generated by the virtual experience providing server.

### EFFECT

As described above, a smart terminal and a virtual clothing experience server provide a virtual experience service of trying on clothing provided from a store, the Internet or a home shopping, irrespective of time and place, using a life-size three-dimensional (3D) avatar of a user and link to a service enabling directly purchase of the clothing after virtual experience, thereby enabling virtual experience of matching information with the clothing or size information on the clothing before purchasing the clothing. Accordingly, unsatisfaction of clothes and returns may be resolved.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an overall configuration of terminals and a server for a virtual clothing experience according to an embodiment;

FIG. 2 illustrates a detailed configuration of a smart terminal according to an embodiment;

FIG. 3 illustrates a detailed configuration of a smart terminal according to another embodiment;

FIG. 4 illustrated a detailed configuration of a virtual experience providing server according to an embodiment;

FIG. 5 illustrates a detailed configuration of a user avatar according to an embodiment;

FIG. 6 illustrates a sweep of a parametric-form user avatar according to an embodiment;

FIG. 7 illustrates a detailed configuration of digital clothing according to an embodiment;

FIG. 8 illustrates a user interface (UI) of a smart terminal for virtually experiencing digital clothing according to an embodiment;

FIG. 9 illustrates an example of clothing identification information on digital clothing according to an embodiment;

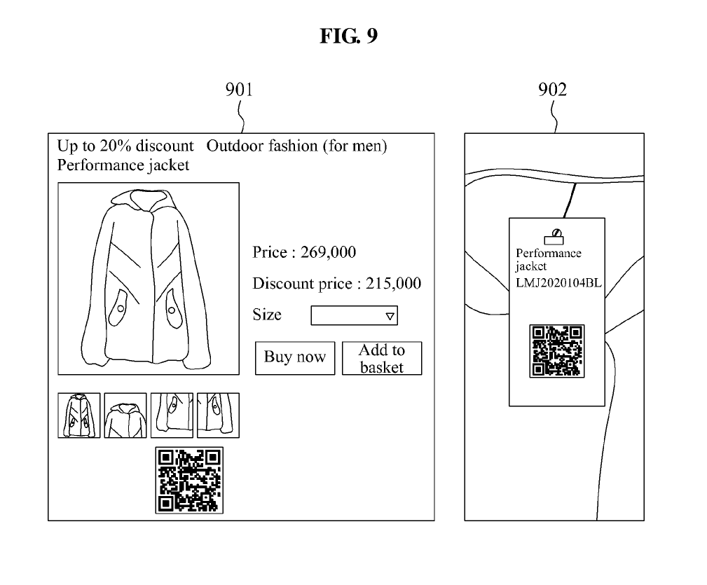

FIG. 10 is a flowchart illustrating overall operations of terminals and a server for a virtual clothing experience according to an embodiment; and

FIG. 11 illustrates a virtual experience service method of a smart terminal according to an embodiment.

### DETAILED DESCRIPTION

Hereinafter, exemplary embodiments of the present invention will be described in detail with reference to the accompanying drawings.

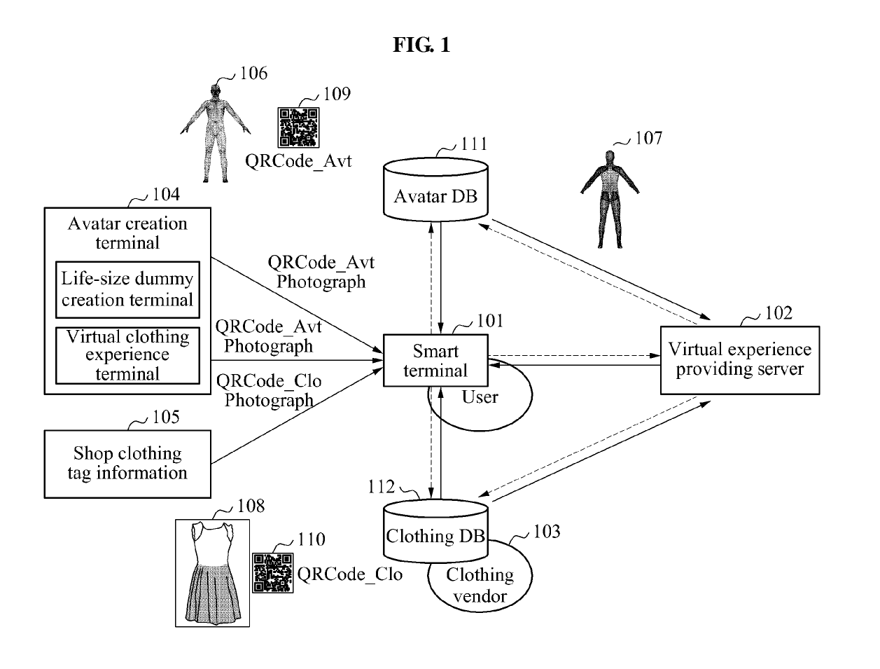

FIG. 1 illustrates an overall configuration of terminals and a server for a virtual clothing experience according to an embodiment.

Referring to FIG. 1, a smart terminal 101 may determine avatar identification information 109 to identify a user avatar created based on body size and appearance information on a user. Here, the avatar identification information 109 may be information created from an avatar creation terminal 104. The avatar creation terminal 104 is a device for measuring body size and appearance information on a user, which may create a user avatar of the user in a three-dimensional (3D) form.

For instance, the avatar creation terminal 104 may include a life-size dummy creation terminal, a virtual clothing experience terminal, or the like. The avatar creation terminal 104 may acquire a depth image and a color image of the user using a depth sensor, a camera, or the like. The avatar creation terminal 104 may reconstruct a 3D whole-body shape of the user based on the depth image and the color image of the user and create a user avatar with the body size and the appearance information on the user reflected corresponding to the reconstructed 3D whole-body shape. The avatar creation terminal 104 may generate the avatar identification information 109 to identify the created user avatar.

Here, to generate the avatar identification information 109, the avatar creation terminal 104 may access a database (DB) in which appearance information and body information of a user are stored online Additionally, the avatar creation terminal 104 may utilize a smart code, for example, a color code or a quick response (QR) code obtained by imaging an identification factor, for example an identification (ID), used to access the DB. Identification information may be broadly interpreted to be exchanged with the identification factor through a bidirectional radio transmission and reception, for example, a beacon.

Two versions of the user avatar, user avatars 106 and 107, may be created so as to protect personal information on the user. In detail, the user avatars 106 and 107 may be created in a 3D mesh form with an average appearance of a human body reflected. Here, the user avatar 106 in the 3D mesh form (also referred to as “3D mesh-form user avatar”) may be an avatar which is formed in a frame structure modeled on a bone structure of the human body to outwardly identify the user.

The user avatars 106 and 107 may be created in a parametric form by numerically expressing outward characteristics based on the 3D mesh-form user avatar. Here, the user avatar 107 in the parametric form (also referred to as “parametric-form user avatar”) numerically expresses the body size and appearance information on the user and thus is suitable to protect the personal information on the user.

The smart terminal 101 may determine clothing identification information 110 to identify digital clothing created corresponding to real clothing. The clothing identification information 110 is information used to identify the digital clothing created corresponding to the real clothing and stored in the DB, similarly to the avatar identification information 109, and may be generated by a clothing vendor 103.

The clothing vendor 103 may be a terminal which converts real clothing into digital clothing to provide the converted digital clothing. The clothing vendor 103 may collect size information on the user avatar from a virtual experience providing server 102 providing digital clothing. Specifically, the clothing vendor 103 may be provided with the size information on the user avatar with processed body sizes or characteristic information on the user avatar from the virtual experience providing server 102.

The clothing vendor 103 may register the size information on the user avatar to collect in the virtual experience providing server 102. The size information may be, for example, information on a height or a waist size of the user avatar. The virtual experience providing server 102 may verify validity of the registered size information on the user avatar regarding infringement of privacy. The virtual experience providing server 102 may finish verifying the validity of the size information that the clothing vendor 103 wants and then provide the size information to the clothing vendor 103 when simulating the digital clothing.

Here, the virtual experience providing server 102 is not allowed to have access to the personal information on the user and thus may interpret numerical information on the user avatar provided for simulation to reconstruct body information. The virtual experience providing server 102 may reconstruct body information on a body, arms, legs, height or the like of the user avatar corresponding to the numerical information to restore a user appearance in a sweep form as a parametric expression. The virtual experience providing server 102 may extract size information on a user avatar desired by the clothing vendor 103 and provide the extracted size information to the clothing vendor 103.

Accordingly, the virtual experience providing server 102 or clothing vendor 103 may extract and provide the size information through reinterpretation of the numerical information without accessing the personal information on the user, so that user privacy and the personal information on the user may be protected.

That is, the clothing vendor 103 has access only to the size information provided through reinterpretation of the numerical information from the virtual experience providing server 102, thereby solving a personal information protection issue caused by user identification and appearance scanning. Further, the size information provided thus may be used for reference when manufacturing clothing with only physical characteristics of the user reflected.

The smart terminal 101 may transmit the determined avatar identification information 109 and clothing identification information 110 to the virtual experience providing server 102.

The virtual experience providing server 102 is allowed to access an avatar DB 111 corresponding to the avatar identification information 109 received from the smart terminal 101. The virtual experience providing server 102 may extract the user avatars 106 and 107 corresponding to the avatar identification information 109 from the avatar DB 111.

The virtual experience providing server 102 is allowed to access a clothing DB 111 corresponding to the clothing identification information 110 received from the smart terminal 101. The virtual experience providing server 102 may extract the digital clothing 108 corresponding to the clothing identification information 110 from the clothing DB 112.

The virtual experience providing server 102 may generate a virtual experience image overlaid on pose information on the user based on the extracted user avatars 106 and 107 and the extracted digital clothing 108. Here, the pose information on the user may include information on a pose that the user strikes while the avatar creation terminal 104 is creating the user avatar. The pose information may include at least one of the color image, joint information corresponding to the pose and the depth information corresponding to the pose.

The virtual experience providing server 102 may provide the generated virtual experience image to the smart terminal 101. The smart terminal 101 may display the virtual experience image provided from the virtual experience providing server 102.

The user may identify matching degree with the digital clothing overlaid on the pose information on the user based on the virtual experience image displayed on the smart terminal 101. When the matching degree with the digital clothing overlaid on the pose information on the user is satisfied, the user may purchase the real clothing corresponding to the digital clothing using a website linked with the smart terminal 101. The user may also purchase the clothing directly from an offline store which sells the real clothing corresponding to the digital clothing.

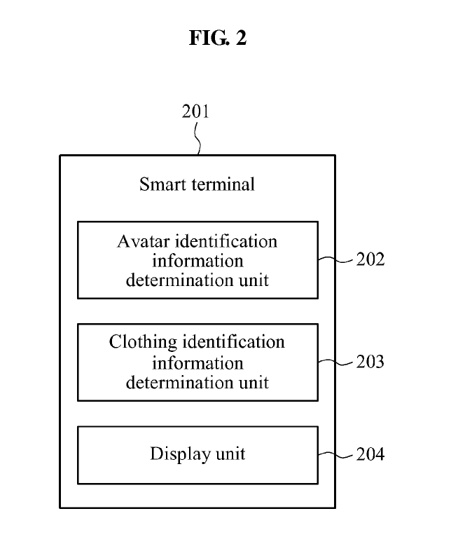

FIG. 2 illustrates a detailed configuration of a smart terminal according to an embodiment.

Referring to FIG. 2, the smart terminal 201 may include an avatar identification information determination unit 202, a clothing identification information determination unit 203, and a display unit 204.

The avatar identification information determination unit 202 may determine avatar identification information to identify a user avatar created from an avatar creation terminal. In detail, the avatar identification information determination unit 202 may select avatar identification information stored in a storage unit of the smart terminal 201 or scan avatar identification information using a camera of the smart terminal 201, thereby determining the avatar identification information. Additionally, unique identification information may be stored in a dedicated application stored in the smart terminal 201.

For instance, the smart terminal 201 may scan the avatar identification information on the user avatar created from the avatar creation terminal using the camera. The smart terminal 201 may store the scanned avatar identification information in the storage unit. The avatar identification information determination unit 202 may determine the avatar identification information in a manner of loading the avatar identification information stored in the storage unit for virtually experiencing digital clothing using the user avatar.

Alternatively, the avatar identification information determination unit 202 may scan avatar identification information using the camera to determine the scanned avatar identification information for virtual experience. That is, if avatar identification information is made as a print, the avatar identification information determination unit 202 may scan the avatar identification information expressed on the print to determine the avatar identification information.

The clothing identification information determination unit 203 may determine clothing identification information to identify digital clothing created from a clothing vendor. The clothing identification information determination unit 203 may select clothing identification information stored in the storage unit of the smart terminal 201 or scan clothing identification information using the camera of the smart terminal 201, thereby determining the clothing identification information.

In an example, the clothing identification information determination unit 203 may scan and determine clothing identification information displayed on the Internet purchase page or present on a tag attached to real clothing displayed in an offline store.

In another example, the clothing identification information determination unit 203 may determine clothing identification information in a manner of loading the clothing identification information photographed and stored by a user in real life.

In still another example, the clothing identification information may include information enabling an identification of clothing worn by a user appeared in a clothing product advertisement, a drama or an entertainment show displayed on a TV. Additionally, the clothing identification information may be displayed on a display of a TV. The smart terminal 201 may scan a portion of the display of the TV, and the clothing identification information determination unit 203 may determine clothing identification information included in the scanned portion.

In yet another example, the clothing identification information may include information enabling an identification of clothing using a clothing advertisement leaflet. The smart terminal 201 may scan a portion of the clothing advertisement leaflet, and the clothing identification information determination unit 203 may determine clothing identification information included in the scanned portion.

In a further example, a management system of a clothing store in which a beacon is installed may transmit clothing identification information to the smart terminal 201 using various wireless transmission and reception technologies, for example, a Bluetooth, ZigBee, a wireless fidelity (WiFi), and the like. The clothing identification information determination unit 203 may interpret the received clothing identification information, to determine the clothing identification information.

In a further example, the clothing identification information determination unit 203 may recognize a clothing brand logo using the camera of the smart terminal 201, and may map the clothing brand logo with a latest clothing product, to determine the clothing identification information.

In a further example, the clothing identification information determination unit 203 may instantly recognize clothing worn by other people using the camera of the smart terminal 201, to determine the clothing identification information.

In a further example, when clothing is searched for from an Internet shopping mall using the smart terminal 201, the clothing identification information determination unit 203 may receive identification information of each of selected items without a need to scan clothing identification information, to determine the clothing identification information.

The display unit 204 may display a virtual experience image overlaid with digital clothing simulated on the user avatar.

For instance, the display unit 204 may display the virtual experience image provided from a virtual experience providing server. That is, the display unit 204 may be provided with and display the virtual experience image from the virtual experience providing server which overlays the digital clothing simulated on the user avatar on user pose information based on the avatar identification information and the clothing identification information.

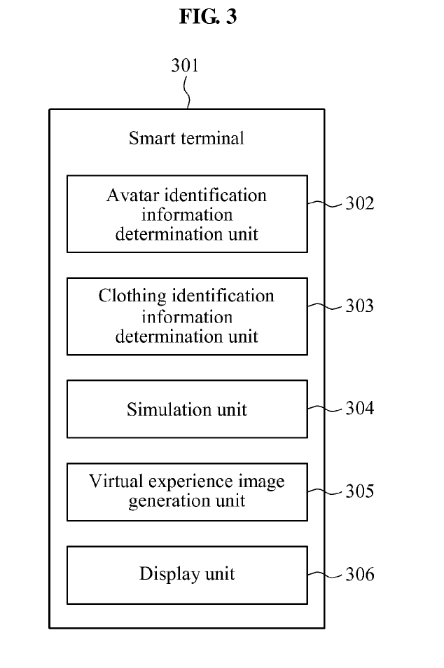

FIG. 3 illustrates a detailed configuration of a smart terminal according to another embodiment.

Referring to FIG. 3, the smart terminal 301 may include an avatar identification information determination unit 302, a clothing identification information determination unit 303, a simulation unit 304, a virtual experience image generation unit 305, and a display unit 306.

The avatar identification information determination unit 302 may determine avatar identification information to identify a user avatar created from an avatar creation terminal. The avatar identification information determination unit 302 may select avatar identification information stored in a storage unit of the smart terminal 301 or scan avatar identification information using a camera of the smart terminal 301, thereby determining the avatar identification information.

The clothing identification information determination unit 303 may determine clothing identification information to identify digital clothing created from a clothing vendor. The clothing identification information determination unit 303 may select clothing identification information stored in the storage unit of the smart terminal 301, or scan or photograph clothing identification information using the camera of the smart terminal 301, thereby determining the clothing identification information.

The simulation unit 304 may simulate the digital clothing on the user avatar based on the avatar identification information and the clothing identification information. In detail, the simulation unit 304 may access an avatar DB corresponding to the avatar identification information. The simulation unit 304 may extract the user avatar corresponding to the avatar identification information from the avatar DB. The simulation unit 304 may access a clothing DB corresponding to the clothing identification information. The simulation unit 304 may extract the digital clothing corresponding to the clothing identification information from the clothing CB.

The simulation unit 304 may change a pose of the user avatar corresponding to user pose information. The simulation unit 304 may simulate the digital clothing on the user avatar whose pose is changed. A simulation scheme may be easily implemented using a physics-based simulation scheme, for example, a NVIDIA's APEX SDK that is frequently used. The simulation unit 304 may simulate the digital clothing on the user avatar, thereby conducting a simulation of an image to be provided to a user.

The virtual experience image generation unit 305 may overlay the simulated digital clothing on a color image of the user pose information, thereby generating a virtual experience image.

The display unit 306 may display the generated virtual experience image.

Here, the smart terminal 301 may have an environment for enabling direct computing of generating the virtual experience image. That is, the smart terminal 301 may have direct access to the user avatar and the digital clothing based on direct computing skills. Specifically, the smart terminal 301 may extract the user avatar corresponding to the avatar identification information using a password for accessing the avatar DB. The smart terminal 301 may extract a 3D mesh-form user avatar in view of a direct computing-enabled environment. The smart terminal 301 may access the clothing DB to extract the digital clothing corresponding to the clothing identification information.

The smart terminal 301 may generate and display the virtual experience image using the extracted user avatar and the extracted digital clothing. Here, a process of the smart terminal 301 generating the virtual experience image may be the same as a process of the virtual experience providing server generating the virtual experience image.

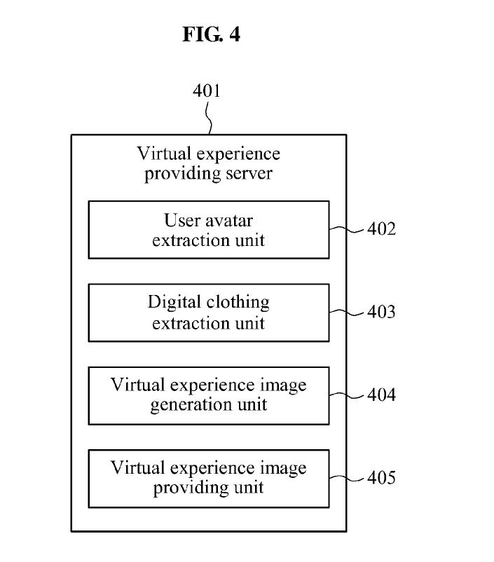

FIG. 4 illustrated a detailed configuration of a virtual experience providing server according to an embodiment.

Referring to FIG. 4, the virtual experience providing server 401 may include a user avatar extraction unit 402, a digital clothing extraction unit 403, a virtual experience image generation unit 404, and a virtual experience image providing unit 405.

The user avatar extraction unit 402 may extract a user avatar corresponding to avatar identification information received from a smart terminal. In detail, the user avatar extraction unit 402 may access an avatar DB storing the user avatar corresponding to the avatar identification information. The user avatar extraction unit 402 may extract the user avatar corresponding to the avatar identification information from the avatar DB. Here, the user avatar extraction unit 402 may extract the user avatar in a 3D mesh form or in a parametric form corresponding to purposes of a virtual experience service provided by the smart terminal

The 3D mesh-form user avatar may be formed in a frame structure modeled on a bone structure of the human body and include personal information on outward characteristics of a user. Since the 3D mesh-form user avatar includes the personal information on the user, a password may be required for access. That is, the 3D mesh-form user avatar uses the password to protect against strangers' access, thereby protecting the personal information on the user.

The parametric-form user avatar is formed by numerically expressing the 3D mesh-form user avatar and includes no personal information on the user. That is, the parametric-form user avatar is an avatar with the personal information on the user encoded by expressing a body size and appearance information on the user in a combination of numbers which is not directly indicated or inferred. Thus, the parametric-form user avatar includes numerical information on the user only and thus may be primarily encoded in a storage scheme, involving a privacy issue regarding the personal information on the user. Accordingly, it is possible to guarantee minimization of damages caused by information exposure.

Moreover, the parametric-form user avatar may apply a password according to an encryption scheme, such as Advanced Encryption Standard (AES), to the parametric-form user avatar, thereby double-protecting the personal information on the user. Further, the parametric-form user avatar may be formed of a negligible size of data, as compared with a data size used to employ the 3D mesh-form user avatar, thereby drastically reducing a transmission load caused by a 3D data size.

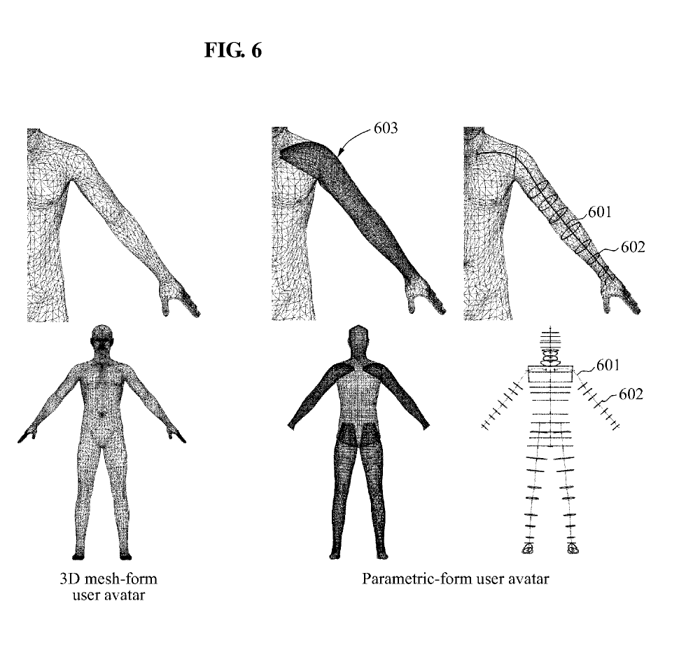

The parametric-form user avatar may be expressed in detail as follows. That is, the parametric-form user avatar may include a non-uniform rational B-spline (NURBS) curve (for example, a NURBS curve 601 of FIG. 6) representing each part corresponding to the frame structure of the 3D mesh-form user avatar, a NURBS curved surface (for example, a NURBS curved surface 602 of FIG. 6) representing an outward characteristic of each part according to the NURBS curve, and a sweep (for example, a sweep 603 of FIG. 6) formed of the NURBS curved surface, which will be described in detail with reference to FIG. 6. Based on a combination of five sweep parts of a human body, an appearance of the human body may be parametrically expressed and a change in a shape based on a change in a frame structure may be expressed.

The digital clothing extraction unit 403 may extract digital clothing corresponding to clothing identification information received from the smart terminal. In detail, the digital clothing extraction unit 403 may access a clothing DB storing the digital clothing corresponding to the clothing identification information. The digital clothing extraction unit 403 may extract the digital clothing corresponding to the clothing identification information from the clothing CB.

The virtual experience image generation unit 404 may generate a virtual experience image overlaid with the digital clothing simulated on the user avatar based on the user avatar and the digital clothing.

In detail, the virtual experience image generation unit 404 may change a pose of the extracted user avatar corresponding to user pose information. The virtual experience image generation unit 404 may change the pose of the user avatar to be equivalent to the pose information using joint information corresponding to the pose included in the user pose information and depth information corresponding to the pose.

The virtual experience image generation unit 404 may simulate the digital clothing on the user avatar whose pose is changed. The virtual experience image generation unit 404 may overlay the simulated digital clothing on the user pose information, thereby generating the virtual experience image.

For instance, the virtual experience image generation unit 404 may render the digital clothing on the 3D mesh-form user avatar to generate a virtual experience image of the digital clothing rendered on the 3D mesh-form user avatar.

Alternatively, the virtual experience image generation unit 404 may generate a virtual experience image using an augmented reality technique. That is, the virtual experience image generation unit 404 may select user pose information stored in the smart terminal. The virtual experience image generation unit 404 may control a pose of the user avatar corresponding to the user pose information. The virtual experience image generation unit 404 may simulate the digital clothing on the user avatar whose pose is controlled. The virtual experience image generation unit 404 may overlay only the simulated digital clothing on a color image included in the user pose information using the augmented reality technique. Finally, the virtual experience image generation unit 404 may generate a virtual experience image of the digital clothing overlaid on the color image.

When the virtual experience image is generated using the augmented reality technique, the virtual experience providing server 401 may provide a user with a virtual experience service of digital clothing corresponding to clothing identification information encountered on a mobile terminal unable to utilize a natural user interface (NUI) sensor, such as Kinect, Internet shopping or home shopping. Here, the virtual experience providing server 401 generates a virtual experience image for digital clothing using a user avatar based on previously generated user identification information, thus providing a virtual digital clothing experience service to a user without infringing personal information.

That is, the virtual experience providing server 401 includes avatar identification information on a previously generated user avatar, and freely simulates digital clothing on the user avatar regardless of place and time and provides a simulation result if the user acquires various pieces of clothing identification information in real life.

Alternatively, the virtual experience image generation unit 404 may provide a virtual experience image in real time based on the user pose information. That is, the virtual experience image generation unit 404 may extract the user pose information in real time in the presence of a depth sensor, such as an NUI sensor including Kinect. The virtual experience image generation unit 404 may simulate the digital clothing in real time based on the user pose information and overlay the simulated digital clothing on the color image included in the user pose information. The virtual experience image generation unit 404 may generate a virtual experience image of the overlaid digital clothing.

When the virtual experience image is provided using the NUI sensor, the virtual experience providing server 401 may overlay the digital clothing on the user pose information provided in real time, so that the user may experience reality on the virtual experience image as if looking in a mirror. The virtual experience providing server 401 may provide a more sophisticated service when linked with an operational device, such as a home TV, Kinect, PC or the like.

When providing a service, the virtual experience image generation unit 404 may generate the virtual experience image using the parametric-form user avatar, thereby securely solving a privacy issue of the user which arises in most terminals. The virtual experience image generation unit 404 may conduct a simulation of putting the digital clothing on the parametric-form user avatar and overlay only the simulated digital clothing on the color image, thereby generating the virtual experience image.

The user may be provided with the virtual experience image of the digital clothing overlaid on the color image and identify matching information or fitting degree to the digital clothing corresponding to various pieces of user pose information. That is, the user may identify how well real clothing fits the user and experience the real clothing in advance before purchasing the real clothing.

The virtual experience image providing unit 405 may provide the generated virtual experience image to the smart terminal.

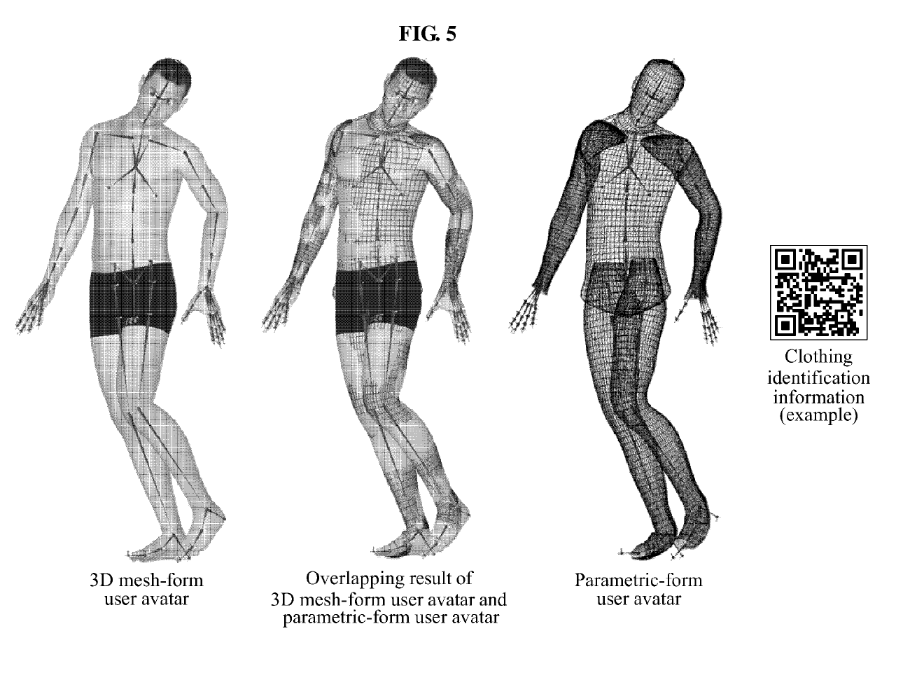

FIG. 5 illustrates a detailed configuration of a user avatar according to an embodiment.

Referring to FIG. 5, the user avatar may include a 3D mesh-form user avatar and a parametric-form user avatar. The user avatar may be generated by modifying a default avatar using measurement information on important body parts of a user. That is, the user avatar may be generated in the 3D mesh-form user avatar and the parametric-form user avatar by automatically matching and changing a control parameter of a parametric sweep expression of the default avatar associated with the information on the body parts corresponding to the measurement information on the body parts of the user.

For example, an avatar creation terminal may simultaneously generate the 3D mesh-form user avatar and the parametric-form user avatar. The 3D mesh-form user avatar and the parametric-form user avatar may be displayed with the same appearance regarding body parts for simulating digital clothing, such as a body, arms and legs, except for a body part relating to privacy, such as a face.

Here, when the user avatar is used in a private PC environment in which the user has direct computing skills based on service purposes, the user may have direct access to the 3D mesh-form user avatar.

On the contrary, when the user avatar is used in a public environment with security vulnerability, such as a server computer, the user may use the parametric-form user avatar, thereby protecting personal information on the user while receiving a virtual clothing experience service.

The user avatar may be mapped with avatar identification information used to access an avatar DB storing user avatars created through the avatar creation terminal.

The avatar identification information may be mapped with the 3D mesh-form avatar and the parametric-form user avatar included in the avatar DB.

FIG. 6 illustrates a sweep of a parametric-form user avatar according to an embodiment.

Referring to FIG. 6, the parametric-form user avatar may be formed of five sweep parts including a body, arms and legs. The five sweep parts may have the same frame structure as that of a 3D mesh-form user avatar and be changed in appearance into the same form by motion control with respect to the frame structure.

The parametric-form user avatar may include the NURBS curve 601 representing each part corresponding to the frame structure of the 3D mesh-form user avatar, the NURBS curved surface 602 representing an outward characteristic of each part according to the NURBS curve, and the sweep 603 formed of the NURBS curved surface 602.

The NURBS curve 601 may represent a bone structure of the five parts including the body arms and legs according to the frame structure. Here, the NURBS curve 601 may represent the bone structure based on a NURBS curve numerically expressing the frame structure.

The NURBS curved surface 602 may numerically represent a shape of a body part parametrically using an intersecting point of a control cross section and a 3D mesh of a default avatar, the control cross section being formed at a position of each joint, for example, a shoulder and elbow, of the frame structure. Here, the default avatar, an avatar which the user avatar is created based on, may be changed based on body measurements of the user.

Further, the NURBS curved surface 602 may represent an appearance of a human to body with a sweep expression by body part by processing a shoulder part or hip part at which sweep expressions overlap each other to intersect.

Here, if the shoulder part or hip part at which sweeps intersect is not processed when an appearance of the user is represented with sweep expressions, an adequate simulation result of digital clothing may not be obtained, and thus the NURBS curved surface 602 may be processed

Thus, in the parametric-form user avatar, sweeps share control cross sections of shoulder joints and hip joints at which sweeps intersect and intersecting points of the cross sections, thereby representing a smooth appearance of the user with parametric sweep expressions.

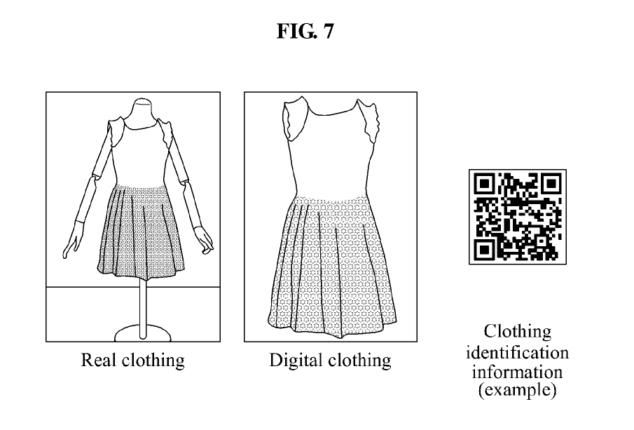

FIG. 7 illustrates a detailed configuration of digital clothing according to an embodiment.

Referring to FIG. 7, the digital clothing may be generated based on real clothing. In detail, the digital clothing may be generated by capturing clothing that a mannequin wears and reconstructing the clothing using image information on the captured clothing. The generated digital clothing may be mapped with clothing identification information used to access a clothing DB storing the digital clothing.

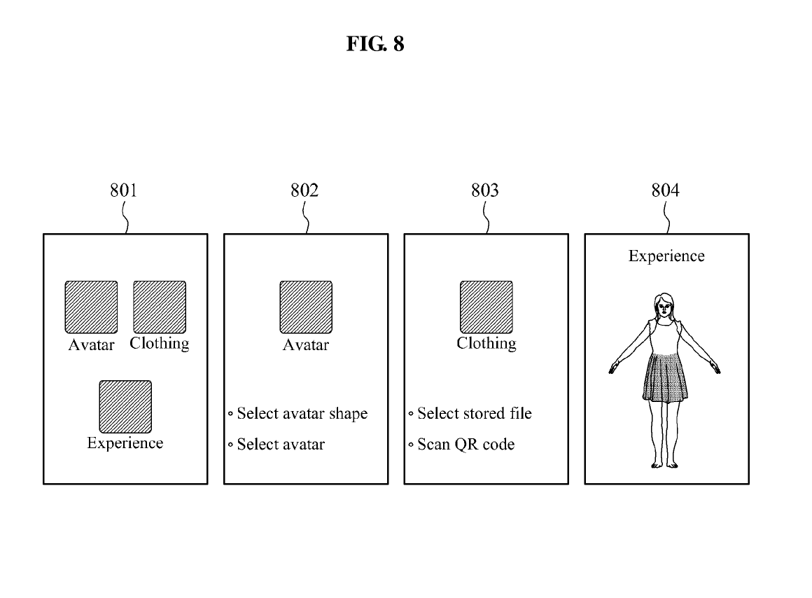

FIG. 8 illustrates a user interface (UI) of a smart terminal for virtually experiencing digital clothing according to an embodiment.

Referring to FIG. 8, the smart terminal may provide a UI 801 to the user as shown in FIG. 7. The user may select one of an avatar, clothing and an experience based on the UI 801.

When the user selects the avatar, the smart terminal may provide a UI 802 for selecting a user avatar. The user may determine avatar identification information including information on the user avatar using the smart terminal. Here, the smart terminal may provide two versions of the user avatar to the user corresponding to the determined avatar identification information. Here, the smart terminal may provide the user with at least one of a 3D mesh-form user avatar and a parametric-form user avatar based on purposes of a service.

When the user selects clothing, the smart terminal may provide a UI 803 for selecting clothing. The user may scan clothing identification information included in a tag attached to clothing displayed in the Internet of an offline store through the smart terminal or select clothing identification information stored in the smart terminal. The clothing identification information may be expressed as shown in FIG. 8.

When the avatar identification information on the user avatar and the clothing identification information on the digital clothing are determined, the smart terminal may be provided with a virtual experience image overlaid with the digital clothing simulated on the user avatar from a virtual experience providing server and display the virtual experience image using a UI 804.

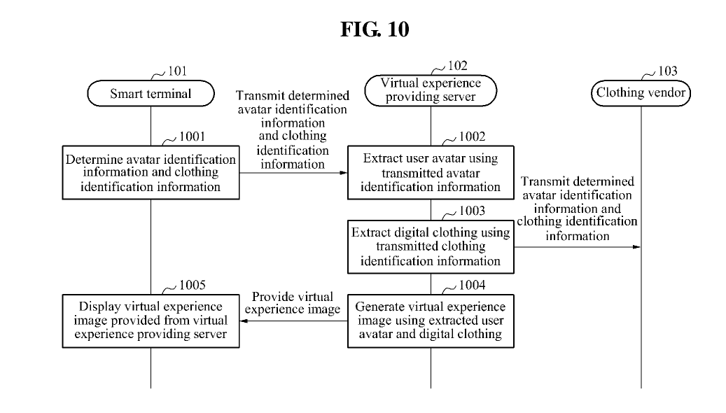

FIG. 10 is a flowchart illustrating overall operations of terminals and a server for a virtual clothing experience according to an embodiment.

In operation 1001, the smart terminal 101 may determine avatar identification information to identify a user avatar. The smart terminal 101 may determine avatar identification information corresponding to a user avatar created from an avatar creation terminal capable of creating a 3D avatar of a user.

The smart terminal 101 may acquire clothing identification information included in a tag attached to clothing displayed on the Internet or in an offline store, or previously stored.

The smart terminal 101 may transmit the determined avatar identification information and clothing identification information to the virtual experience providing server 102.

In operation 1002, the virtual experience providing server 102 may extract the user avatar using the avatar identification information provided from the smart terminal 101. The virtual experience providing server 102 may access an avatar DB storing the user avatar corresponding to the avatar identification information to extract the user avatar corresponding to the avatar identification information.

Here, the virtual experience providing server 102 may extract the user avatar in a 3D mesh form or in a parametric form corresponding to purposes of a virtual experience service provided by the smart terminal 101.

In operation 1003, the virtual experience providing server 102 may extract the digital clothing corresponding to the clothing identification information provided from the smart terminal 101. The virtual experience providing server 102 may access a clothing DB storing the digital clothing corresponding to the clothing identification information to extract the digital clothing corresponding to the clothing identification information.

Here, the virtual experience providing server 102 may provide size information on the user avatar to the clothing vendor 103 by access to the clothing DB. The virtual experience providing server 102 may interpret numerical information on the user avatar to reconstruct body information and provide size information desired by the clothing vendor 103.

In operation 1004, the virtual experience providing server 102 may generate a virtual experience image using the extracted user avatar and the extracted digital clothing. The virtual experience providing server 102 may change a pose of the user avatar to correspond to user pose information using joint information corresponding to the pose included in the user pose information and depth information corresponding to the pose and simulate the digital clothing on the user avatar.

The virtual experience providing server 102 may overlay the digital clothing simulated on the user avatar on a color image included in the user pose information, thereby generating a virtual experience image.

The virtual experience providing server 102 may provide the generated virtual experience image to the smart terminal 101.

In operation 1005, the smart terminal 101 may display the virtual experience image provided from the virtual experience providing server 102.

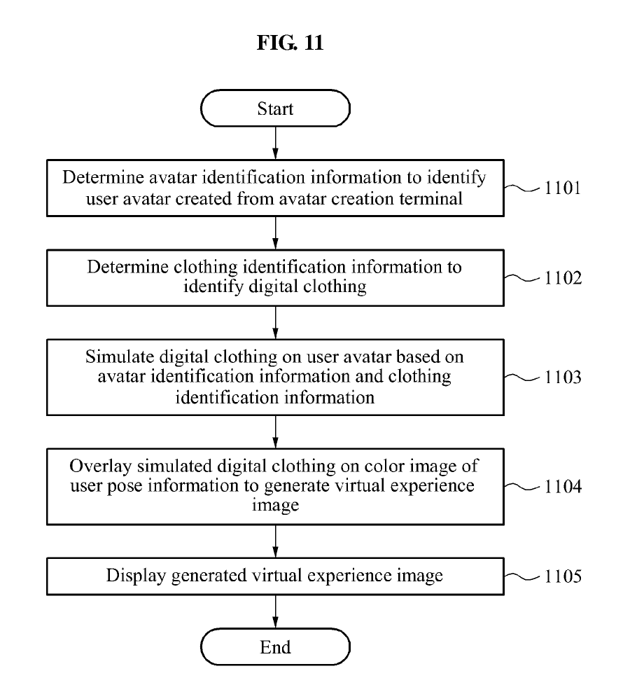

FIG. 11 illustrates a virtual experience service method of a smart terminal according to an embodiment.

In operation 1101, the smart terminal may determine avatar identification information to identify a user avatar created from an avatar creation terminal.

In operation 1102, the smart terminal may determine clothing identification information to identify digital clothing created from a clothing vendor.

In operation 1103, the smart terminal may simulate the digital clothing on the user avatar based on the avatar identification information and the clothing identification information. The smart terminal may have direct access to the user avatar and the digital clothing. That is, the smart terminal may directly access an avatar DB and a clothing DB to extract the user avatar and the digital clothing corresponding to the avatar identification information and the clothing identification information.

The smart terminal may simulate the user avatar and the digital clothing based on user pose information.

In operation 1104, the smart terminal may overlay the simulated digital clothing on a color image of the user pose information, thereby generating a virtual experience image.

In operation 1105, the smart terminal may display the generated virtual experience image.

The foregoing methods according to the exemplary embodiments of the present invention may be recorded in non-transitory computer-readable media including program instructions to implement various operations embodied by a computer. The media may also include, alone or in combination with the program instructions, data files, data structures, and the like. The program instructions recorded in the media may be designed and configured specially for the present invention or be known and available to those skilled in computer software.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention.

Therefore, the scope of the present invention is not limited to the foregoing exemplary embodiments but is defined by the claims and their equivalents.

What is claimed is:

1. A virtual experience service method performed by a smart terminal, the method comprising:
determining avatar identification information to identify a user avatar created from an avatar creation terminal;
determining clothing identification information to identify digital clothing; and
displaying a virtual experience image overlaid with the digital clothing simulated on the user avatar,
wherein the displaying is provided with and displays the virtual experience image from a virtual experience providing server overlaying the digital clothing simulated on the user avatar on user pose information based on the avatar identification information and the clothing identification information.

2. The method of claim 1, wherein the user avatar comprises a user avatar in a three-dimensional (3D) mesh form constructed in a frame structure modeled on a bone structure of a human body, and a user avatar in a parametric form obtained by numerically expressing outward characteristics of the user avatar in the 3D mesh form.

3. The method of claim 2, wherein the user avatar in the parametric form comprises a non-uniform rational B-spline (NURBS) curve representing each part corresponding to the frame structure of the user avatar in the 3D mesh form, an NURBS curved surface representing an outward characteristic of each part according to the NURBS curve, and a sweep formed of the NURBS curved surface.

4. The method of claim 1, wherein the determining of the avatar identification information determines the avatar identification information by selecting avatar identification information stored in a storage unit of the smart terminal or by scanning avatar identification information using a camera of the smart terminal.

5. The method of claim 1, wherein the determining of the clothing identification information determines the clothing identification information by selecting clothing identification information stored in a storage unit of the smart terminal or by scanning clothing identification information using a camera of the smart terminal

6. The method of claim 2, wherein the displaying displays the virtual experience image overlaid with the digital clothing simulated on at least one of the user avatar in the 3D mesh form and the user avatar in the parametric form.

7. The method of claim 1, wherein the user pose information comprises at least one of a color image corresponding to a pose that a user strikes while the user avatar is created from the avatar creation terminal, joint information corresponding to the pose, and depth information corresponding to the pose.

8. A virtual experience service method performed by a smart terminal, the method comprising:
determining avatar identification information to identify a user avatar created from an avatar creation terminal;
determining clothing identification information to identify digital clothing;
simulating the digital clothing on the user avatar based on the avatar identification information and the clothing identification information;
generating a virtual experience image by overlaying the simulated digital clothing on a color image of user pose information; and
displaying the generated virtual experience image.

9. A virtual experience service method performed by a virtual experience providing server, the method comprising:
extracting a user avatar corresponding to avatar identification information received from a smart terminal;
extracting digital clothing corresponding to clothing identification information received from the smart terminal;
generating a virtual experience image overlaid with the digital clothing simulated on the user avatar based on the user avatar and the digital clothing; and
providing the generated virtual experience image to the smart terminal,
wherein the providing provides the generated virtual experience image to the smart terminal which transmits the avatar identification information and the clothing identification information to the virtual experience providing server and is provided with and displays the virtual experience image generated by the virtual experience providing server.

10. The method of claim 9, wherein the extracting of the user avatar extracts at least one of a user avatar in a three-dimensional (3D) mesh form and a user avatar in a parametric form.

11. The method of claim 9, wherein the generating of the virtual experience image changes a pose of the extracted user avatar corresponding to user pose information, and the user pose information comprises at least one of a color image corresponding to a pose that a user strikes while the user avatar is created, joint information corresponding to the pose, and depth information corresponding to the pose.

12. The method of claim 11, wherein the generating of the virtual experience image simulates the extracted digital clothing on the user avatar whose pose is changed and overlays the simulated digital clothing on the user pose information to generate the virtual experience image.
